(19) United States
(12) Patent Application Publication
(10) Pub. No.: US 2019/0026706 A1
(43) Pub. Date: Jan. 24, 2019

(54) METHOD OF CREATING AND MAINTAINING A STABLE CRYPTO-CURRENCY

(71) Applicant: James E. Satloff, New York, NY (US)

(72) Inventor: James E. Satloff, New York, NY (US)

(21) Appl. No.: 16/013,033

(22) Filed: Jun. 20, 2018

Related U.S. Application Data
(60) Provisional application No. 62/536,048, filed on Jul. 24, 2017.

(51) Int. Cl. G06Q 20/06

(52) U.S. Cl. CPC G06Q 20/0655

(57) ABSTRACT

A method of creating and maintaining a stable crypto-currency comprises the steps of:
(a) offering for sale a prescribed first amount of a first crypto-currency at a prescribed first price-per-unit of the first currency, pursuant to an established offering policy setting forth the terms of sale;
(b) selling said first amount of the first crypto-currency at the aforesaid first price-per-unit for cash proceeds of at least one other second currency having a known market value;
(c) pursuant to the offering policy, purchasing marketable assets for which a specific value can be determined, using the proceeds of sale of the at least one other second currency;
(d) if the market value of the first crypto-currency falls significantly below the aforesaid first price-per-unit, using the marketable assets to purchase units of the first crypto-currency sufficient to increase the price-per-unit thereof to approximately the first price-per-unit.

This method works first to create the first crypto-currency and then to automatically stabilize the market value of the first crypto-currency at approximately the first price-per-unit.

### CROSS-REFERENCE TO RELATED APPLICATION

This application claims priority from the U.S. Provisional Application No. 62/536,048 filed Jul. 24, 2017.

### BACKGROUND OF THE INVENTION

The present invention relates to the field of crypto-currencies, such as bitcoin, ethereum, and litecoin, which exhibit properties similar to government-issued currencies usable within defined borders and yet allow for instantaneous transactions and borderless transfer-of-ownership. More particularly, the present invention relates to a method of providing and maintaining a crypto-currency in such a way as to stabilize the value of the currency.

Currencies issued by a single country, such as the United States of America, or a governmental organization representing a group of countries, such as the European Union and the United Kingdom, are supported and backed by the “full faith and credit” of the issuer and/or, in some cases, by physical assets such as gold. These currencies fluctuate in value with respect to their purchasing power, and with respect to each other, only to limited extent and in a relatively predictable manner. Stability and security of these currencies are maintained by centralized governmental banks which promulgate rules and regulations and which issue tamper-resistant physical documents that represent the units of currency or “coin” as “legal tender.”

Crypto-currencies, in contrast, use strong cryptography as a means to secure their use in financial transactions, to control the creation of additional currency, and to verify the transfer of these digital assets. Crypto-currencies are stabilized by their market value; that is, by supply and demand. Supply is based on a number of factors which include ‘mining,’ or the creation of new currency based on predetermined criteria that amount to contributions to a public workload using computing power. Demand is based on a number of factors, including speculative forces.

Crypto-currencies are generally transacted on exchanges (coinbase, gdax, etc.) where market-driven values for each currency are displayed in real time or near real time. The decentralized control of a crypto-currency works through a distributed ledger technology, called a “blockchain,” that serves as a public financial transaction database.

Consequently, typical crypto-currencies have no intrinsic value and represent, effectively, “fiat” capital.

### SUMMARY OF THE INVENTION

A principal objective of the present invention is to provide a method of creating and maintaining a crypto-currency in a manner such that the value of the currency will remain substantially stable over time.

This objective, as well as other objectives which will become apparent from the discussion that follows, are achieved, according to the present invention, by a method comprising the steps of:

(a) offering for sale a prescribed first amount of a first crypto-currency at a prescribed first price-per-unit of the first currency, pursuant to an established offering policy setting forth the terms of sale;
(b) selling said first amount of the first crypto-currency at the aforesaid first price-per-unit for cash proceeds of at least one other second currency having a known market value;
(c) pursuant to the offering policy, purchasing marketable assets for which a specific value can be determined, using the proceeds of sale of the at least one other second currency;
(d) if the market value of the first crypto-currency falls significantly below the aforesaid first price-per-unit, using the marketable assets to purchase units of the first crypto-currency sufficient to increase the price-per-unit thereof to approximately the first price-per-unit.

Similarly, if the market value of the first crypto-currency rises significantly above the first price-per-unit, selling the marketable assets in return for cash of the first crypto-currency, thus lowering the marketable asset value which supports the price-per-unit of the first crypto-currency, sufficient to lower the price-per-unit thereof to approximately the first price-per-unit.

As used in this context, the term “significantly” is intended to mean a noticeable change in excess of normal market fluctuations.

The method described above thus works to create the first crypto-currency and to automatically stabilize the market value of the first crypto-currency at approximately the first price-per-unit.

According to the invention, the method further comprises the additional steps of offering for sale a prescribed second amount of the first crypto-currency at a prescribed second price-per-unit; selling the second amount of the first crypto-currency at the second price-per-unit for cash proceeds of the at least one other second currency; and, pursuant to the established offering policy, purchasing additional marketable assets for which a specific value can be determined, using the proceeds of the at least one other second currency. In this way, the supply of the first crypto-currency is increased while maintaining its stable asset value. Advantageously, the second price-per-unit is chosen to be the same as the first price-per-unit.

Such additional steps of the method are preferably carried out at prescribed regular intervals. Preferably also, the market value of the first crypto-currency is monitored and is disclosed publically at prescribed regular intervals.

The present invention thus provides a crypto-currency that is backed by actual assets, rather than fiat capital. The physical assets form an effective minimum value of the currency, and should the market value drop below some predetermined percentage of the book value of the currency, this would trigger a purchase in the open market of currency using the assets that back the currency generally. This combined reduction of supply and increase in demand would increase the price of the currency, stabilizing it. Compared with free-floating currencies that have no asset backing, the currency contemplated herein would allow for a stable, usable, tradable, store of value.

Purchasers of this currency or “coin” at the “initial coin offering”—or “ICO”—would receive the coin at the initial price. The proceeds from this offering would be kept securely by the creators and managers of the crypto-currency.

The use of the proceeds could be varied and numerous, including gold, other crypto-currencies, or other items for which a specific value can be determined.

In a preferred embodiment, the assets from the coin's ICO could be used to create an investment fund, divided in some proportion between a portfolio of other crypto-currencies and private equity investments in crypto-currency related companies (such as those essential to maintenance and employment of crypto-currencies' blockchains or open ledgers).

Holders of the crypto-currency coin would have no claim to the assets of the currency other than being able to rely on the stability thereof. The coin would be freely exchangeable into other currencies (either crypto-currency or government currencies) at the then published exchange rates.

In this embodiment, the managers of crypto-currency coin assets would strive to invest such capital for the highest long-term return, and could be compensated for their services. Should the managers prove successful, this would raise the asset value (or “book value”) of the currency, raising the intrinsic value of each unit or coin.

On a periodic basis, which could be quarterly, monthly, daily, or even in real-time, if the exchange value of a crypto-currency coin dropped below a predetermined percentage of an intended value, programmatic purchase of the coin using the held assets would commence.

### BRIEF DESCRIPTION OF THE DRAWING

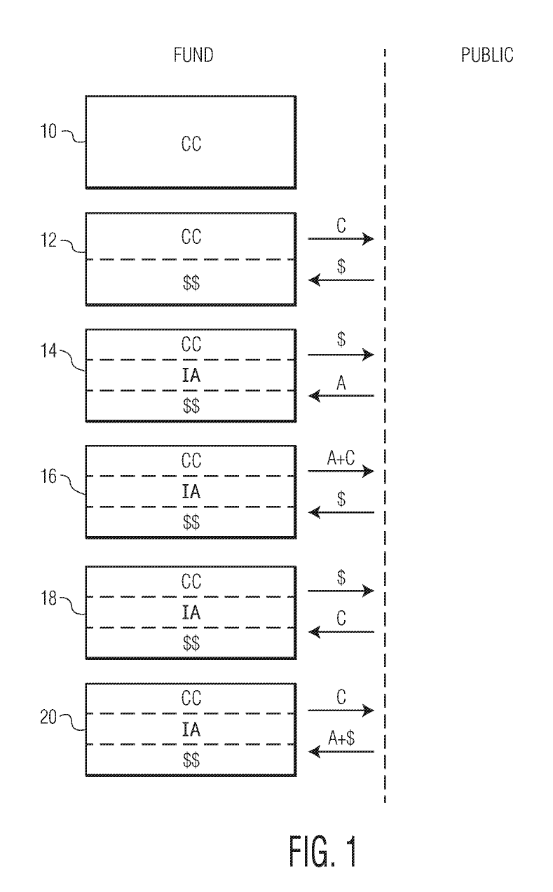

The single FIG. 1 is a representational diagram showing the steps of the method according to the present invention.

### DESCRIPTION OF THE PREFERRED EMBODIMENTS

FIG. 1 illustrates a platform for the method according to the present invention. The left side of the FIGURE shows a fund, represented by blocks 10-20, which is controlled by the managers of the crypto-currency. The right side of the FIGURE represents the public.

Initially, the fund (block 10) contains only a created amount of crypto-currency (“CC”), some or all of which will be offered to the public. Thereafter, at block 12, a specified amount of coin (“C”) of the CC is sold to the public for cash of any common currency, shown here as U.S. currency (“$”). The fund will then contain both an amount of CC and an amount of $$.

Next, at block 14, some cash ($) is used to purchase assets (“A”) for investment. These assets may comprise securities, gold or any other relatively liquid assets, such as other crypto-currency. The fund then contains CC, the remaining cash ($$) and also the investment assets (“IA”).

If additional cash (“$”) is needed for any reason, either assets (A) or coin (C), or both, can be sold to the public, as shown at block 16.

This enables the fund to buy back crypto-currency coin (C) on the open market for cash, as shown at block 18.

Conversely, as shown at block 20, the fund can sell more crypto-currency coin (C) to the public in return for cash ($) or investment assets.

Based on this platform, which operates according to an established crypto-currency offering policy, it is possible to manage the fund to carry out the method according to the present invention. By way of example and not limitation, the method may include the following steps:

1) The crypto-currency coin is issued through an initial crypto-currency coin offering (ICO). For example, a 10 mm supply with initial cost of $100 each would yield proceeds of $1B, and would establish a “book value” of $100/currency unit.
2) The assets raised are used as a “value store” for the currency. Unlike other crypto-currencies which are effectively fiat capital, this currency would be backed by assets, much as the dollar was on the gold standard.
3) The assets would be placed into a fund that would do two things: a) purchase other crypto-currencies as a long-term investment, b) purchase interests in crypto-currency companies. This fund could operate much like a hedge fund.
4) If the traded value of the crypto-currency dropped significantly below the book value of the fund's assets, the fund would purchase the currency on the open market (much like the U.S. Federal Reserve does now). This would have the effect of raising the price of the currency.
5) Each month, additional currency would be added to the system for a) liquidity reasons, and b) to generate a management fee (for example, of 2% per annum).
6) Any gain in the fund assets could be split, 20% to the fund manager(s) and 80% to remain in the fund (much like a classic 2-and-20 hedge fund compensation).
7) The holders of the crypto-currency would not have any legal claim on the assets of the fund, nor would they be limited or general partners of the fund.
8) The crypto-currency would be traded on the crypto-currency exchanges like any other such currency, with the added security that it is backed by assets.
9) The “book value,” referred to in steps Nos. 1 and 4 above, would be published publicly, on an monthly or quarterly basis to provide transparency for the market.

There has thus been shown and described a method creating and maintaining a crypto-currency which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A method of creating and maintaining a stable crypto-currency, said method comprising the steps of:
(a) offering for sale a prescribed first amount of a first crypto-currency at a prescribed first price-per-unit of said first currency, pursuant to an established offering policy setting forth the terms of sale;
(b) selling said first amount of said first crypto-currency at said first price-per-unit for cash proceeds of at least one other second currency having a known market value;
(c) pursuant to the offering policy, purchasing marketable assets for which a specific value can be determined, using said proceeds of sale of said at least one other second currency;
(d) if the market value of the first crypto-currency falls significantly below said first price-per-unit, using said marketable assets to purchase units of said first crypto-currency sufficient to increase the price-per-unit thereof to approximately said first price-per-unit;
thereby to stabilize the market value of said first crypto-currency at approximately said first price-per-unit.

2. The method defined in claim 1, if the market value of the first crypto-currency rises significantly above the first price-per-unit, further comprising the additional steps of selling the marketable assets in return for cash of the first crypto-currency, thus lowering the marketable asset value which supports the price-per-unit of the first crypto-currency, sufficient to lower the price-per-unit thereof to approximately the first price-per-unit.

3. The method defined in claim 1, further comprising the additional steps of offering for sale a prescribed second amount of first crypto-currency at a prescribed second price-per-unit; selling said second amount of said crypto-currency at said second price for cash proceeds of said at least one other second currency; and pursuant to the Offering Agreement, purchasing additional marketable assets for which a specific value can be determined, using said proceeds of said at least one other second currency.

4. The method defined in claim 3, wherein the additional steps are repeatedly carried out at prescribed regular intervals.

5. The method defined in claim 3, wherein said second price-per-unit is the same as said first price-per-unit.

6. The method defined in claim 1, further comprising the steps of monitoring the market value of said first crypto-currency and publicly disclosing said market value at prescribed regular intervals.
